(19) United States
(12) Patent Application Publication
(10) Pub. No.: US 2008/0142690 A1
(43) Pub. Date: Jun. 19, 2008

(54) OPTICAL TRACKBALL

(76) Inventors: Yung-Lung Liu, Taichung Hsien (TW); Shin-Pin Lin, Taichung Hsien (TW)

Correspondence Address: G. LINK CO., LTD., 3550 BELL ROAD, MINOOKA, IL, 60447, US

(21) Appl. No.: 11/564,985

(22) Filed: Nov. 30, 2006

(51) Int. Cl. H01J 40/14; G06M 7/00; G01N 21/86; G01V 8/00

(52) U.S. Cl. 250/221; 250/559.1; 250/559.29

(57) ABSTRACT

A trackball in one embodiment includes a PCB including an aperture, a socket including upper and lower chambers communicated with each other, rollers disposed around bottom of the upper chamber, a ball rotatably supported by the rollers, a ring cover secured to the socket, a light guide plate mounted between the socket and the PCB and including an inclined light guide tube and an optical element; and an optical assembly mounted under the aperture and including a light source (e.g., LED) for emitting light through the light guide tube prior to impinging on the ball, and a photosensor. Rolling the ball will reflect the light from the ball through the optical element to be received by the photosensor such that the rotational movement of the ball can convert into a digital signal useable to move a cursor a corresponding distance and direction on a display.

### BACKGROUND OF THE INVENTION

1. Field of Invention

The present invention relates to trackballs and more particularly to a relatively small optical trackball with improved resolution, the optical trackball adapted to mount on a computer keyboard, a notebook computer, or even on the phone body of a mobile phone.

2. Related Art

Conventionally, a desktop computer is equipped with a trackball or a mouse (or a notebook computer is equipped with a trackball) as a pointing device for cursor on its video display screen. The construction and operation of a conventional optomechanical trackball are detailed below. A ball contacts two shaft encoders and rotation of the ball rotates the shaft encoders. Each shaft encoder comprises an encoding wheel having slits thereon. A light source is positioned on one side of the encoding wheel, while a photosensor is positioned opposite the light source. Rotation of the encoding wheel therebetween causes a series of light pulses to be received by the photosensor. Thereafter, the rotational movement of the ball can be converted into a digital signal useable to move a cursor.

However, the well known trackball suffered from several disadvantages. For example, its mechanism is typically relatively complex in constructions, it is trouble-prone due to foreign objects entering, it has a reduced useful time, it is relatively bulky, and its manipulation or operation is not smooth.

There is an electronic trackball available. The trackball comprises a light source for emitting light to impinge on a ball, and a photosensor for receiving light pulses reflected from the ball in response to the rotational movement of the ball.

However, the well known electronic trackball has a number of disadvantages. For example, the number of components is relatively large, resulting in an increase of difficulty of assembly or disassembly for repair. Further, rotation of the ball is not smooth. Furthermore, its resolution is low because the ball and its adjacent components are of same color (i.e., no contrast). Thus, the need for improvement still exists.

### SUMMARY OF THE INVENTION

It is therefore an object of the present invention to provide a trackball for controlling the position of a cursor on a display of a personal computer, a notebook computer, or a mobile phone, comprising a PCB including an aperture therethrough; a cylindrical socket including an upper chamber, a lower chamber in communication with the upper chamber, a plurality of arcuately recessed seats equally spaced around a bottom of the upper chamber, and a plurality of rollers each disposed in the seat; a ball mounted in the upper chamber and having a lower portion rotatably supported by the rollers and being partially projected into the lower chamber; a ring cover secured to the socket for allowing an upper portion of the ball partially projected therefrom; a light guide plate mounted between the socket and the PCB and including an inclined light guide tube having both ends in communication with the lower chamber and the aperture respectively, and an optical element located adjacent the light guide tube and above the aperture; and an optical assembly mounted under the aperture and including a light source for emitting light through the light guide tube prior to impinging on the lower portion of the ball, and a photosensor located adjacent the light source, whereby rolling the projected upper portion of the ball will reflect the light from the lower portion of the ball to the photosensor through the optical element to be received by the photosensor such that the rotational movement of the ball is adapted to convert into a digital signal useable to move the cursor a corresponding distance along a corresponding direction on the display.

It is another object of the present invention to provide a trackball for controlling the position of a cursor on a display of a personal computer, a notebook computer, or a mobile phone, comprising a PCB including an aperture therethrough; a cylindrical socket including an upper chamber, a lower chamber in communication with the upper chamber, a plurality of arcuately recessed seats equally spaced around a bottom of the upper chamber, and a plurality of rollers each disposed in the seat; a ball mounted in the upper chamber and having a lower portion rotatably supported by the rollers and being partially projected into the lower chamber; a ring cover secured to the socket for allowing an upper portion of the ball partially projected therefrom; a light guide plate mounted between the socket and the PCB and including an inclined light guide tube having an upper end extended into the lower chamber and a lower end proximate the light source, and an optical element located adjacent the light guide tube and above the aperture; a light source mounted under the PCB for emitting light through the light guide tube prior to impinging on the lower portion of the ball; and a photosensor located under the aperture, whereby rolling the projected upper portion of the ball will reflect the light from the lower portion of the ball to the photosensor through the optical element to be received by the photosensor such that the rotational movement of the ball is adapted to convert into a digital signal useable to move the cursor a corresponding distance along a corresponding direction on the display.

In one aspect of the present invention the light source is a LED.

In another aspect of the present invention the ball is translucent formed by mixing a transparent plastic material with aluminum powder and molding same with randomly distributed speckles formed thereon.

In a further aspect of the present invention the optical element is a lens.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of optical trackball according to the present invention;

FIG. 2 is an exploded view of the trackball;

FIG. 3 is a longitudinal sectional view of the trackball;

FIG. 4 is an environmental view of the trackball mounted on a keyboard; and

FIG. 5 is a longitudinal sectional view of a second preferred embodiment of optical trackball according to the present invention; and

FIG. 6 is an exploded view of the trackball shown in FIG. 5.

### DETAILED DESCRIPTION OF THE INVENTION

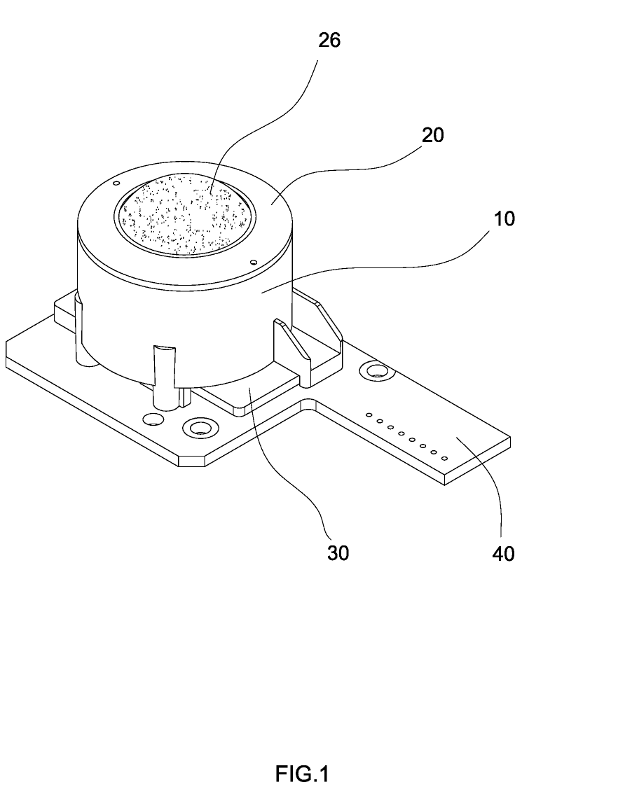

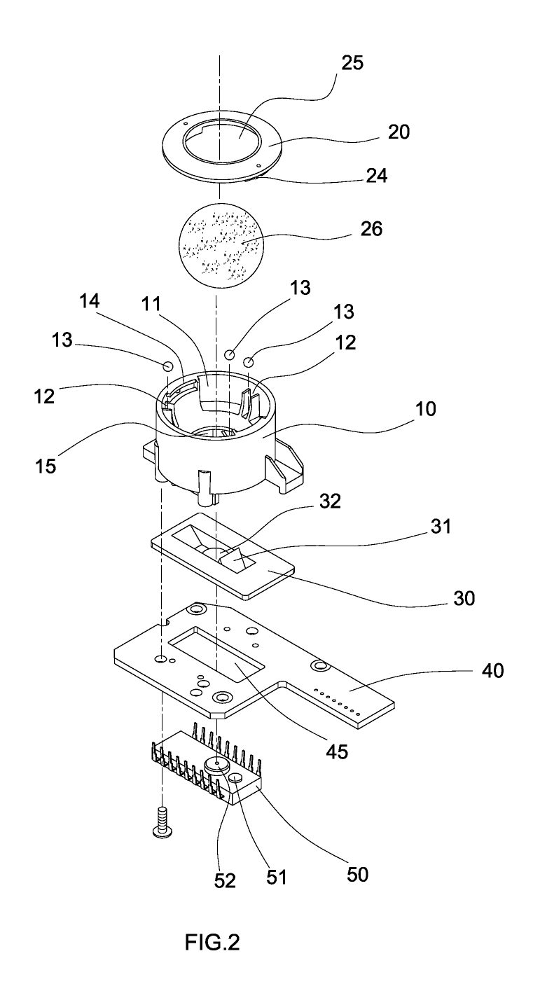

Referring to FIGS. 1 to 4, an optical trackball in accordance with a first preferred embodiment of the present invention comprises a socket 10, a ring cover 20, a ball 26, a light guide plate 30, and an optical assembly 50. Each component is discussed in detailed below.

The cylindrical socket 10 is mounted above a PCB (printed circuit board) 40. An internal space of the socket 10 is divided into a substantially bowl-shaped upper chamber 11 and a lower chamber 16 in communication with the upper chamber 11 through a circular opening 15 formed therebetween. A plurality of arcuately recessed seats 12 are equally formed around a bottom of the upper chamber 11. A plurality of rollers 13 each is disposed in the seat 12. The ball 26 is mounted in the upper chamber 11 and has its lower portion rotatably supported by the rollers 13. Further, the ball 26 has one portion projected out of a circular opening 25 of the ring cover 20 and the other opposite portion projected out of the opening 15. Two opposite projections 14 are formed on a top inner edge of the socket 10 such that the socket 10 and the ring cover 20 can be secured together by securing the projections 14 to mated grooves 24 on an underside of the ring cover 20 as well known in the art. Also, the ball 26 is positioned.

The ball 26 is formed by mixing a transparent plastic material with aluminum powder and molding same. The formed ball 26 is translucent and has randomly distributed speckles formed thereon, resulting in a contrast with the surrounding environment. This also has the effect of increasing reflectance, resulting in an increase of the resolution and a saving of energy.

The rectangular light guide plate 30 is mounted between the socket 10 and the PCB 40, i.e., under the lower chamber 16. The light guide plate 30 comprises an inclined light guide tube 31 having both ends in communication with a top (i.e., facing the lower chamber 16) and a bottom (i.e., facing the PCB 40). The light guide plate 30 further comprises an optical element (e.g., lens) 32 about in a center adjacent the light guide tube 31.

The rectangular optical assembly 50 is mounted under the PCB 40 and is aligned with a rectangular aperture 45 of the PCB 40. Also, both the light guide tube 31 and the optical element 32 are aligned with the aperture 45 as the light guide plate 30 is mounted on the PCB 40. The optical assembly 50 comprises a light source (e.g., LED (light-emitting diode)) 51 for emitting light, and a photosensor 52 such as a phototransistor.

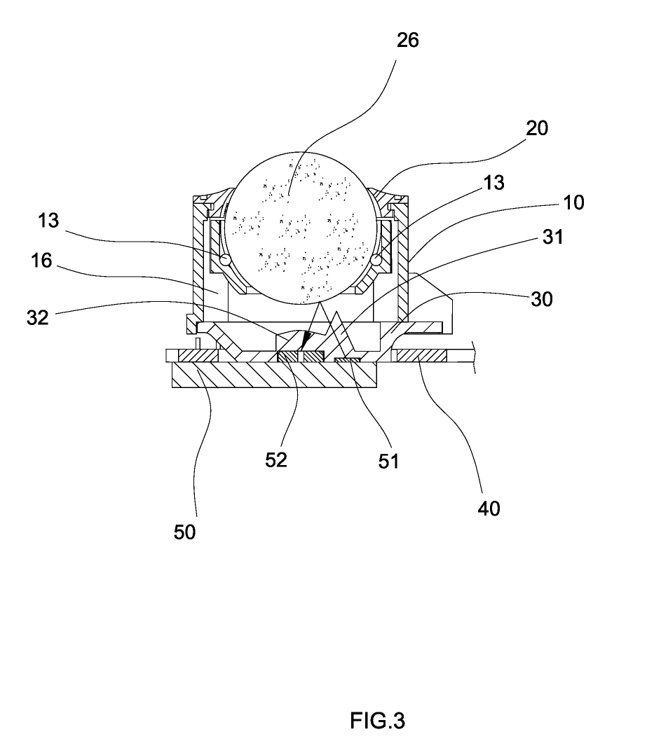

An operation of the present invention will be described in detailed below by referring to FIG. 3 specifically. A user may roll the ball 26 with the thumb, fingers, or palm of the hand by contacting the exposed portion of the ball 26. Light emitted by the light source 51 passes the light guide tube 31 to impinge on the lower portion of the ball 26. And in turn, light is reflected from the ball 26 to penetrate the optical element 32 after passing the lower chamber 16. Next, the light is received by the photosensor 52. The received light is in the form of a series of light pulses. Therefore, the rotational movement of the ball 26 can be converted into a digital signal useable to move a cursor a direction and distance proportioned to the rotation of the ball 26 on a video display screen.

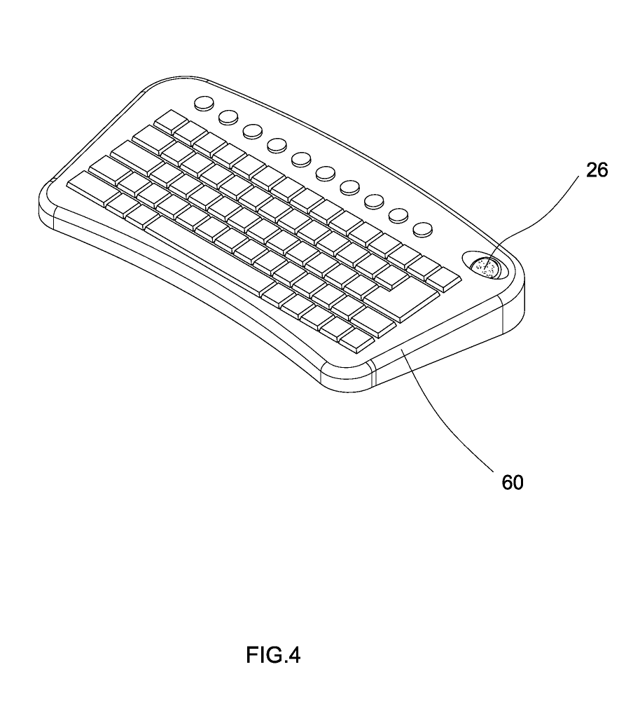

In one application, the small optical trackball is mounted on a computer keyboard 60 with the ball 26 being exposed (see FIG. 4). In another application, the small optical trackball can be even mounted on the phone body of a mobile phone.

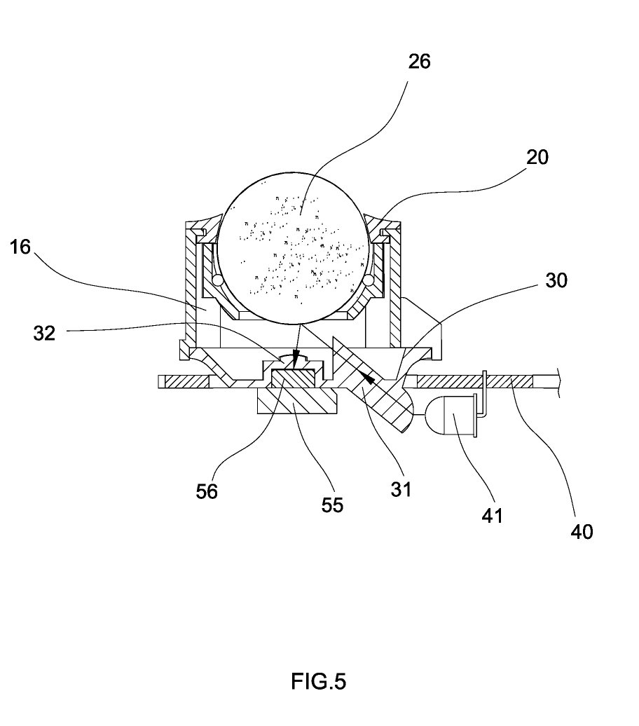

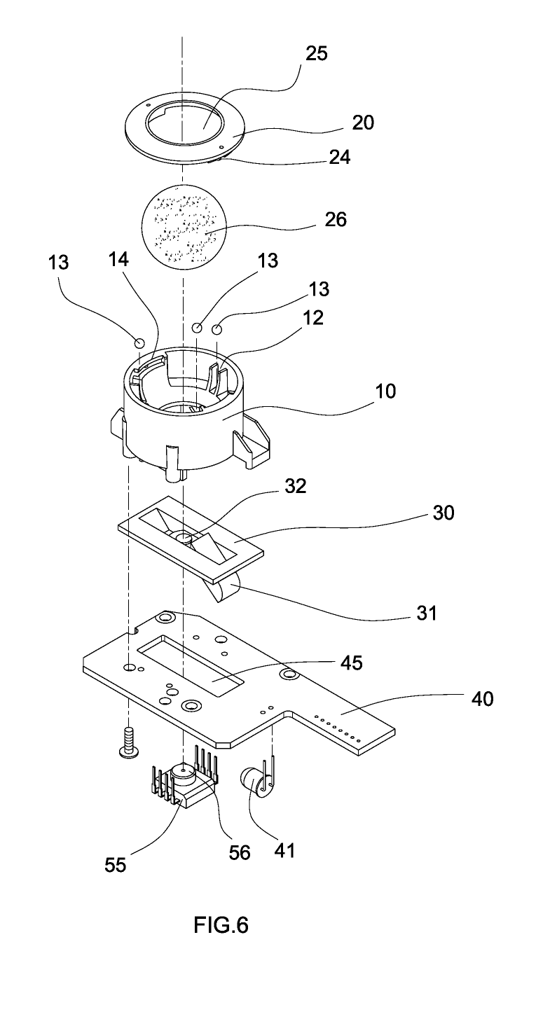

Referring to FIGS. 5 and 6, an optical trackball in accordance with a second preferred embodiment of the present invention is shown. The second embodiment is identical to the first embodiment, except that a light source (e.g., LED) 41 is mounted under the PCB 40 adjacent the aperture 45, an optical assembly 55 only comprises a photosensor 56, and the light guide tube 31 is further inclined downward to be proximate the light source 41. Similar to the first embodiment, light emitted by the light source 41 impinges on the ball 26 after being deflected by and through the light guide tube 31. And in turn, light reflected from the ball 26 is received by the photosensor 52 after penetrating the optical element 32. The received light is in the form of a series of light pulses. Therefore, the rotational movement of the ball 26 can be converted into a digital signal useable to move a cursor a direction and distance proportioned to the rotation of the ball 26 on a video display screen.

In either embodiment the optical trackball can obtain an improved resolution. Moreover, the optical trackball is simple in construction, is easy to assemble or detach, and is easy to manipulate or operate.

While the present invention herein disclosed has been described by means of specific embodiments, numerous modifications and variations could be made thereto by those skilled in the art without departing from the scope and spirit of the invention set forth in the claims.

What is claimed is:

1. A trackball for controlling the position of a cursor on a display of a personal computer, a notebook computer, or a mobile phone, comprising:
a PCB including an aperture therethrough;
a cylindrical socket including an upper chamber, a lower chamber in communication with the upper chamber, a plurality of arcuately recessed seats equally spaced around a bottom of the upper chamber, and a plurality of rollers each disposed in the seat;
a ball mounted in the upper chamber and having a lower portion rotatably supported by the rollers and being partially projected into the lower chamber;
a ring cover secured to the socket for allowing an upper portion of the ball partially projected therefrom;
a light guide plate mounted between the socket and the PCB and including an inclined light guide tube having both ends in communication with the lower chamber and the aperture respectively, and an optical element located adjacent the light guide tube and above the aperture; and
an optical assembly mounted under the aperture and including a light source for emitting light through the light guide tube prior to impinging on the lower portion of the ball, and a photosensor located adjacent the light source,
whereby rolling the projected upper portion of the ball will reflect the light from the lower portion of the ball to the photosensor through the optical element to be received by the photosensor such that the rotational movement of the ball is adapted to convert into a digital signal useable to move the cursor a corresponding distance along a corresponding direction on the display.

2. The trackball of claim 1, wherein the light source is a LED.

3. The trackball of claim 1, wherein the ball is translucent formed by mixing a transparent plastic material with aluminum powder and molding same with randomly distributed speckles formed thereon.

4. The trackball of claim 1, wherein the optical element is a lens.

5. A trackball for controlling the position of a cursor on a display of a personal computer, a notebook computer, or a mobile phone, comprising:
a PCB including an aperture therethrough;
a cylindrical socket including an upper chamber, a lower chamber in communication with the upper chamber, a plurality of arcuately recessed seats equally spaced around a bottom of the upper chamber, and a plurality of rollers each disposed in the seat;
a ball mounted in the upper chamber and having a lower portion rotatably supported by the rollers and being partially projected into the lower chamber;
a ring cover secured to the socket for allowing an upper portion of the ball partially projected therefrom;
a light guide plate mounted between the socket and the PCB and including an inclined light guide tube having an upper end extended into the lower chamber and a lower end proximate the light source, and an optical element located adjacent the light guide tube and above the aperture;
a light source mounted under the PCB for emitting light through the light guide tube prior to impinging on the lower portion of the ball; and
a photosensor located under the aperture,
whereby rolling the projected upper portion of the ball will reflect the light from the lower portion of the ball to the photosensor through the optical element to be received by the photosensor such that the rotational movement of the ball is adapted to convert into a digital signal useable to move the cursor a corresponding distance along a corresponding direction on the display.

6. The trackball of claim 5, wherein the light source is a LED.

7. The trackball of claim 5, wherein the ball is translucent formed by mixing a transparent plastic material with aluminum powder and molding same with randomly distributed speckles formed thereon.

8. The trackball of claim 5, wherein the optical element is a lens.
